(19) United States
(12) Patent Application Publication
(10) Pub. No.: US 2006/0074638 A1
(43) Pub. Date: Apr. 6, 2006

(54) Speech file generating system and method

(75) Inventors: Jenny Xu, Taipei (TW); Chaucer Chiu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/001,860

(22) Filed: Nov. 30, 2004

(30) Foreign Application Priority Data
Sep. 27, 2004 (TW) 093129194

(51) Int. Cl. G10L 21/00

(52) U.S. Cl. 704/201

(57) ABSTRACT

A speech file generating system and a speech file generating method are applicable to a data processing device. A resource access module is connected via a preset resource path to a speech resource supply device to access speech resources according to access conditions. Then, a format of the accessed speech resources are transformed by a file format transformation module into a preset file format, and the speech resources that fulfill the preset file format are subjected to post-processing by a process interface and tool of a post processing module. The post-processed speech resources are stored in a database. By the speech file generating system and method, a user can process the accessed speech resources into speech learning resources that fulfill particular requirements, so as to achieve a personalized language learning environment for increasing learning efficiency.

### FIELD OF THE INVENTION

The invention relates to speech file generating systems and methods, and more particularly, to a speech file generating system and method applicable to a data processing device.

### BACKGROUND OF THE INVENTION

With a rapid advance in the development of electronic information industry, a variety of powerful and budget electronic information products have began to appear in the market. For example, a large number of data processing devices having language learning function are available for the consumers who wish to communicate with people speaking in foreign languages. When the language learning is conducted via the data processing device, such as computer or electronic dictionary, the researcher has to deal with the issues as to provide the learner with an almost human-like environment, so as to achieve language learning merely via the interacting with the data processing device instead of actual human interaction.

The speech learning function is provided in a manner that simulates a real person teaching situation. As the current data processing device has been gradually developed with an increased data processing efficiency and data storage capacity, processing of a speech effect that is close to a person's original voice no longer creates a hassle for the researcher. In the conventional speech learning system and method, a portion of pre-recorded speech file is played. After the learner listened a certain portion or entire part, he/she usually has to follow again. However, the learner can not evaluate the learning effect on his/her own by such learning method. Later, the researcher has come up with another speech learning system with identification function. According to this speech learning system, learner's following speech is recorded. And a degree of variation is determined between the pre-recorded speech and the following speech via an identification mechanism so as to evaluate the learner's learning effect.

Although the conventional speech learning system described above provides the learner with a simulated two-way learning environment where the learner can both listen and speak, the speech data is pre-recorded in the system by the speech learning system manufacturer. So, even if the learner may obtain updated or extended speech data online or from other data storage units, the learner is still unable to set a related speech learning environment according to self-learning situation and need, such as setting specific learning paragraph, setting original subtitle and/or translation subtitle. As a result, the speech learning efficiency is not improved.

Therefore, the problem to be solved here is to provide a speech file generating system and method for setting a learning environment according to self-learning situation and need for the learner.

### SUMMARY OF THE INVENTION

In light of the drawbacks above, a primary objective of the present invention is to provide a speech file generating system and method so as to allow the learner to set a learning environment according to self-learning situation and needs.

In accordance with the above and other objectives, the present invention proposes a speech file generating system, which comprises a resource access module connected to a speech resource supply device via a preset resource path and for accessing speech resources according to access conditions; a file format transformation module for transforming a format of the accessed speech resources into a preset file format; a post processing module for providing a process interface and tool for post-processing the speech resources that fulfill the preset file format; and a database for storing the post-processed speech resources.

In the use of the speech file generating system, a speech file generating method is carried out, comprising the steps of: providing a resource access module connected to a speech resource supply device via a preset resource path, and accessing speech resources via the resource access module according to access conditions; providing a file format transformation module for transforming a format of the accessed speech resources into a preset file format; providing a post processing module having a process interface and tool for post-processing the speech resources that fulfill the preset file format; and providing a database for storing the post-processed speech resources.

In contrast to the conventional speech file generating technique, the speech file generating system and method provide a speech file post-process mechanism, so as to set a learning environment according to self-learning situation and needs for the learner.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing basic architecture of a speech file generating system according to the present invention; and

FIG. 2 is a flowchart showing a speech file generating method according to the present invention.

### DETAILED DESCRIPTION OF THE PREFERRED EMBODIMENTS

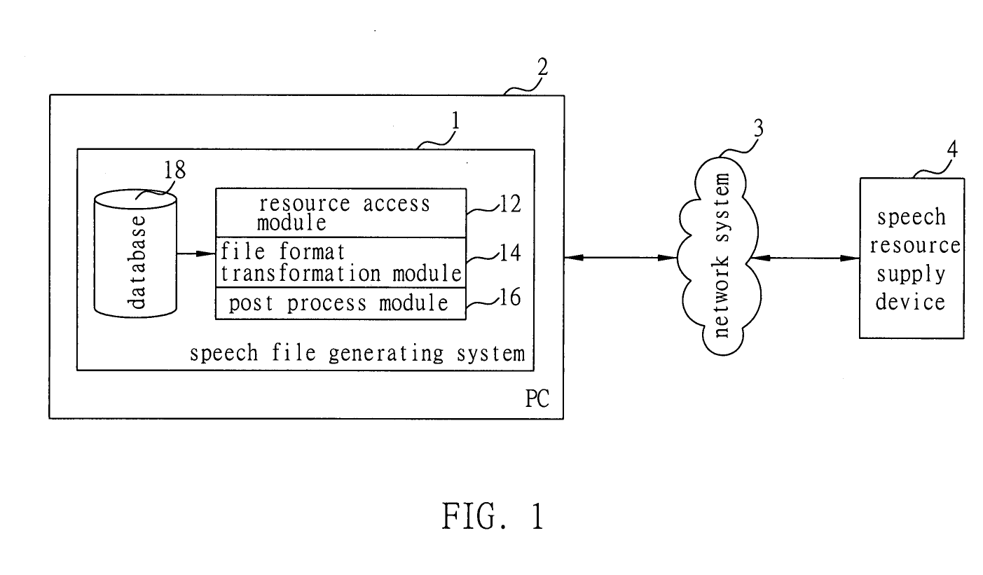

Referring to FIG. 1, a speech file generating system 1 includes a resource access module 12, a file format transformation module 14, a post processing module 16, and a database 18.

In this embodiment, the speech file generating system 1 is applicable to a personal computer (PC) 2. More specifically, the speech file generating system 1 serves to provide voiced language learning function in the PC 2. It should be noted that the PC 2 further comprises other software and/or hardware for data computation. However, only parts related to the speech file generating system 1 are illustrated to avoid complicating the technical feature of the present invention. Moreover, the PC 2 may also be replaced by electronic dictionary, personal digital assistant (PDA), mobile phone, or other data processing devices capable of supporting speech input/output functions. Preferably, the PC 2 further includes a network connection function, so as to connect via a network system 3 to other speech resource supply devices 4, such as a server device for access of the speech resource.

The resource access module 12 is connected via a preset resource path to the speech resource supply device to access the speech resource according to the access conditions. In this embodiment, the resource path may be a hard disk device, compact disc storage, and other external storage devices, such as Universal Serial Bus (USB) thumb drive or card reader connected to the PC 2. Alternatively, the resource path may be the resource supply device 4 such as web server or file server on a resource address that fulfills Uniform Resource Locators (URL) protocol, wherein the URL protocol may be HTTP, Gopher, News, FTP or Telnet. The resource access module 12 may be connected to the speech resource supply device 4 via the network system 3.

Also, the resource access module 12 may provide an input interface to which the user inputs one of the resource paths described above via the PC 2. And the resource access module 12 is connected via the resource path to the hard disk device, compact disc storage device, external storage unit, and/or other resource supply devices, such as the web server or the file server. The resource access module 12 further stores the accessed speech resource into the hard disk device, compact disc storage device, and/or external storage unit connected to the PC 2.

The file format transformation module 14 serves to transform the accessed speech resource format into a preset file format. In this embodiment, the preset speech resource file is a “.WAV” file having a digital audio file format commonly used in the PC 2. Therefore, when the speech resources such as “.mp3”, “.wma”, and “.rm” having speech file format other than “.WAV” are accessed by the resource access module 12, the file format transformation module 14 transforms these speech resources having speech file formats other than “.WAV” into the “.WAV” file format.

While the file format transformation module 14 transforms the original audio frequency and recorded audio frequency into waveform signals, the original audio frequency and recorded audio frequency are set by the conventional frequency-setting mechanism into different sample frequencies (44 kHz, 22 kHz or 11 kHz), bit sizes (8 bits or 16 bits), and monotone/stereosound. It should be noted that file format transformation module 14 may also adopt other frequency waveform signal transformation formats, such as “.au”, “.snd”, “.voc”, “.aiff”, “.afc”, “.iff” or “.mat”. These conventional frequency waveform signal transformation formats are well known to one ordinary skilled in the art, and the details thereof are not further described herein.

The post processing module 16 provides process interface and tool for post-processing the speech resource of the preset file format transformed by the file format transformation module 14. In this embodiment, the post processing module 16 allows the user to perform post processes comprising at least steps of interruption point searching, time spacing, original subtitling, and translation subtitling via the PC 2. The time spacing involves cutting a line of speech resource into at least a section, whereas the interrupting point searching involves assigning a search title for each cut section so that the user can conduct a search from. The original subtitling enables the user to input and set the original subtitle corresponding to the speech resource, so that the original subtitle is synchronously illustrated as a reference for the user when the speech resource is played. The translation subtitling enables the user to input and set the translation subtitle corresponding to the speech resource, so that the translation subtitle is synchronously illustrated as a reference for the user when the speech resource is played. Preferably, the original subtitling and translation subtitling are set to synchronously illustrate during the process of playing the speech resource, so as to increase learning efficiency for the learner, particularly the novice.

The database 18 stores the post-processed speech resource. In this embodiment, as the speech resource is post-processed by the post processing module 16, the database 18 may be installed to the hard disk device, compact disc storage device, and other external storage units associated with or connected to the PC 2 to store the speech resource processed by the post processing module 16, so as to prevent complicating with the original speech resource accessed according the access conditions. The speech resource may be the speech resource that is subject to the post process including interruption point searching, time spacing, original subtitling, and translation subtitling.

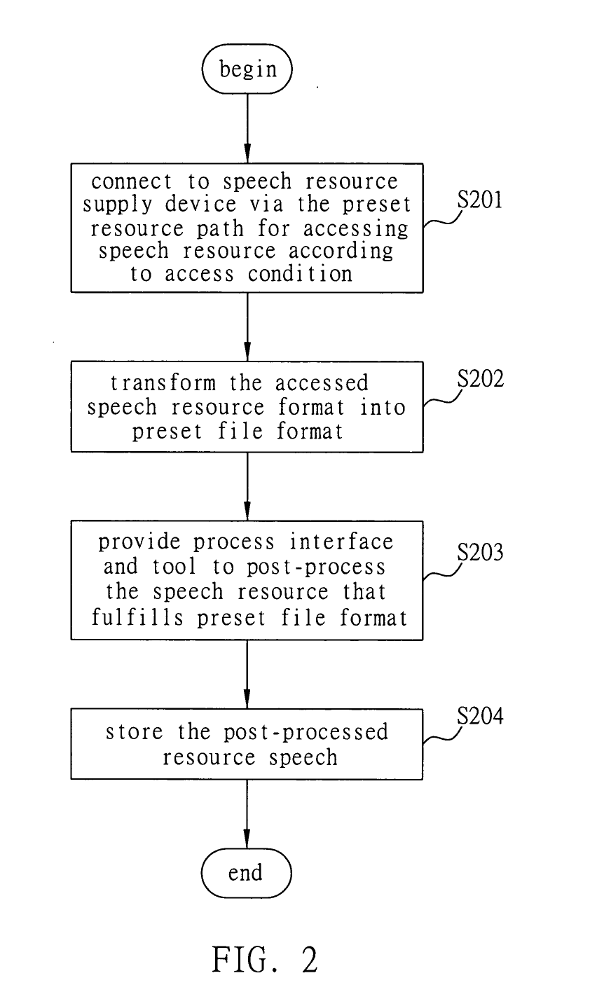

Referring to FIG. 2, it shows a speech file generating method in the use of the above speech file generating system 1 according to the present invention.

In step S201, the resource access module 12 is provided to connect via the preset resource path to the speech resource supply device and access the speech resource according to the access conditions. In this embodiment, the resource path may be a hard disk device, compact disc storage, and other external storage units, such as Universal Serial Bus (USB) thumb drive or card reader connected to the PC 2. Alternatively, the resource path may be the resource supply device 4 such as web server or file server on a resource address that fulfills Uniform Resource Locators (URL) protocol.

Also, the resource access module 12 may provide an input interface to which the user inputs one of the resource paths described above via the PC 2. And the resource access module 12 is connected via the resource path to resource supply device for access of the resource, particularly the speech resource provided by the resource supply device. The resource access module 12 further stores the accessed speech resource into the hard disk device, compact disc storage device, and/or other external storage units associated with or connected to the PC 2. Next, the method proceeds to step S202.

In step S202, the file format transformation module 14 is provided to transform the accessed speech resource format into a preset file format. In this embodiment, the preset speech resource file is a “.WAV” file having a digital audio file format commonly used in the PC 2. Therefore, when the speech resources having speech file format other than “.WAV” are accessed by the resource access module 12, these speech resources having speech file formats other than “.WAV” are transformed into the “.WAV” file format.

Also, as the file format transformation module 14 transforms the original audio frequency and recorded audio frequency into waveform signals, the original audio frequency and recorded audio frequency may be set by the conventional frequency-setting mechanism into different sample frequencies (44 kHz, 22 kHz or 11 kHz), bit sizes (8 bits or 16 bits), and monotone/stereosound. Next, the method proceeds to step S203.

In step S203, the post processing module 16 having process interface and tool is provided for post-processing the speech resource of the preset file format transformed by the file format transformation module 14. In this embodiment, the post processing module 16 allows the user to perform post processes comprising at least steps of interruption point searching, time spacing, original subtitling, and translation subtitling via the PC 2. The time spacing involves cutting a line of speech resource into at least a section, whereas the interrupting point searching involves assigning a search title for each cut section so that the user can conduct a search from. The original subtitling enables the user to input and set the original subtitle corresponding to the speech resource, so that the original subtitle is synchronously illustrated as a reference for the user when the speech resource is played. The translation subtitling enables the user to input and set the translation subtitle corresponding to the speech resource, so that the translation subtitle is synchronously illustrated as a reference for the user when the speech resource is played. Preferably, the original subtitling and translation subtitling are set to synchronously illustrate during the process of playing the speech resource, so as to increase learning efficiency for the learner, particularly the novice. Next, the method proceeds to step S204.

In step S204, the database 18 is provided to store the post-processed speech resource. In this embodiment, after the speech resource is post-processed by the post processing module 16, the database 18 may be installed to the hard disk device, compact disc storage device, and other external storage units associated with the PC 2 to store the speech resource processed by the post processing module 16, so as to prevent complicating with the original speech resource accessed according the access conditions. And the speech resource may be the speech resource subject to the post process including interruption point searching, time spacing, original subtitling, and translation subtitling.

Summarizing from the above, the speech file generating system and method provide a speech file post-processing mechanism, so as to allow the learner to set the desired speech learning environment according to self-learning situation and need. Therefore, the learner can process the accessed speech resource into speech learning resource that fulfills the specific need, so as to achieve a personalized speech-learning environment for improving efficiency in learning.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A speech file generating system applicable to a data processing device, the system comprising:
a resource access module connected to a speech resource supply device via a preset resource path, and for accessing speech resources according to access conditions;
a file format transformation module for transforming a format of the accessed speech resources into a preset file format;
a post processing module having a process interface and tool for post-processing the speech resources that fulfill the preset file format; and
a database for storing the post-processed speech resources.

2. The speech file generating system of claim 1, wherein the resource path includes a hard disk device, a compact disc storage device and an external storage unit that are connected to the data processing device, and a resource supply device fulfilling Uniform Resource Locator (URL) protocol.

3. The speech file generating system of claim 1, wherein the resource access module further provides an input interface for inputting the resource path via the data processing device.

4. The speech file generating system of claim 2, wherein the resource access module further stores the accessed speech resources in one of the hard disk device, the compact disc storage device and the external storage device that are connected to the data processing device.

5. The speech file generating system of claim 1, wherein the preset file format is one selected from the group consisting of “.wav”, “.au”, “.snd”, “.voc”, “.aiff”, “.afc”, “.iff” and “.mat”.

6. The speech file generating system of claim 5, wherein the file format transformation module transforms a speech file format of the speech resources other than the preset file format into the preset file format.

7. The speech file generating system of claim 6, wherein the speech file format other than the preset file format is one selected from the group consisting of “.mp3”, “.wma” and “.rm”.

8. The speech file generating system of claim 1, wherein the post processing module allows a user to perform via the data processing device at least one post process selected from the group consisting of interruption point searching, time spacing, original subtitling, and translation subtitling.

9. The speech file generating system of claim 2, wherein the database is mounted in the hard disk device, the compact disc storage device, or the external storage device.

10. A speech file generating method applicable to a data processing device, the method comprising the steps of:
providing a resource access module connected to a speech resource supply device via a preset resource path, and accessing speech resources via the resource access module according to access conditions;
providing a file format transformation module for transforming a format of the accessed speech resources into a preset file format;
providing a post processing module having a process interface and tool for post-processing the speech resources that fulfill the preset file format; and
providing a database for storing the post-processed speech resources.

11. The speech file generating method of claim 10, wherein the resource path includes a hard disk device, a compact disc storage device and an external storage unit that are connected to the data processing device, and a resource supply device fulfilling Uniform Resource Locator (URL) protocol.

12. The speech file generating method of claim 10, wherein the resource access module further provides an input interface for inputting the resource path via the data processing device.

13. The speech file generating method of claim 11, wherein the resource access module further stores the accessed speech resources in one of the hard disk device, the compact disc storage device and the external storage unit that are connected to the data processing device.

14. The speech file generating method of claim 10, wherein the preset file format is one selected from the group consisting of “.wav”, “au”, “.snd”, “.voc”, “.aiff”, “.afc”, “.iff” and “.mat”.

15. The speech file generating method of claim 14, wherein the file format transformation module transforms a speech file format of the speech resources other than the preset file format into the preset file format.

16. The speech file generating method of claim 15, wherein the speech file format other than the preset file format is one selected from the group consisting of “.mp3”, “.wma” and “.rm”.

17. The speech file generating method of claim 10, wherein the post processing module allows a user to perform via the data processing device at least one post process selected from the group consisting of interruption point searching, time spacing, original subtitling, and translation subtitling.

18. The speech file generating method of claim 11, wherein the database is mounted in the hard disk device, the compact disc storage device, or the external storage unit.
